(19) United States
(12) Patent Application Publication
(10) Pub. No.: US 2002/0116305 A1
(43) Pub. Date: Aug. 22, 2002

(54) Method for aligning financial and logistical flows with an internet exchange portal

(76) Inventor: Raj Abhyanker, Cupertino, CA (US)

Correspondence Address: HEWLETT-PACKARD COMPANY, Intellectual Property Administration, P.O. Box 272400, Fort Collins, CO, 80528-9599, US

(21) Appl. No.: 09/785,760

(22) Filed: Feb. 16, 2001

(51) Int. Cl. G06F 17/60

(52) U.S. Cl. 705/35; 705/37

(57) ABSTRACT

A method for aligning financial and logistical flows within a business to business internet exchange portal is disclosed. The method of the present invention includes the steps of facilitating an auction on the portal between a buyer and a seller; collecting a set of shipping data for a contract entered into between the buyer and seller resulting from the auction; soliciting bids for shipping services required by the contract; receiving a set of shipping bids; and selecting a bid from the set of bids according to a predetermined set of bid evaluation criteria.

### BACKGROUND OF THE INVENTION

1. Field of the Invention

The present invention relates generally to methods for arranging financing and shipping within an e-commerce supply chain environment, and more particularly for aligning financial and logistical flows with an internet exchange portal.

2. Discussion of Background Art

In this modern information age, an increasing number of business transactions and logistical services are provided over computer networks. Internet exchange systems are one example of such “virtual” networks.

FIG. 1 is a dataflow diagram of an example of an internet exchange system 100 configured to operate as an online Business-to-Business (B2B) auction. In the system 100 a seller 102 seeks to enter a transaction with a buyer 104 for a sale of goods or services through an internet exchange portal 106. The portal 106 hosts a service for connecting willing buyers and sellers, through perhaps using an auctioning system where sellers shop for buyers willing to pay most for a seller's goods, and buyers shop for least expensive seller's goods. Typically, the seller 102 and buyer 104 independently log on to the portal over lines 108 and 110 respectively. The seller 102 then advertises goods for sale and the buyer 104 searches for goods to purchase.

In order to finance auction bids, some buyers pre-arrange for payment using credit from flooring companies. Flooring companies typically extend credit to buyers for purchasing a predetermined set of goods and/or services. Flooring is typically arranged in advance of a buyer's bid to purchase goods and often flooring providers transfer the credited funds directly to sellers upon the buyer's instructions. Unlike conventional letters of credit, however, buyers typically cannot use flooring credit for purchasing office equipment, or other goods and/or services beyond those specifically pre-approved by the flooring company. In some cases, buyers may even have to apply to multiple flooring providers until sufficient flooring credit is obtained.

In a web-based auction environment, however, goods and service appear and disappear at a very rapid rate, providing little time for buyers to apply for and for flooring companies to decide whether to provide flooring. Furthermore, since flooring providers need to know which specific goods and/or services the buyer wishes to bid upon before even considering the buyer's flooring application, conventional buyer-managed flooring application practices introduce a significant time delay between when the buyer identifies goods and/or services to be bid upon over the auction site, and when the buyer receives flooring credit approval from one or more flooring companies so that a bid can actually be made. Buyers thus often lose many opportunities to purchase goods and/or services in the auction environment. Such problems are further compounded when buyers are regular auction participants and repeatedly need to seek and receive flooring credit.

After the buyer 104 obtains flooring over line 109 from a flooring company 111, the buyer 104 may make a bid for the goods and/or services offered by the seller 102 over the portal 106. Once the seller 102 and buyer 104 have agreed to enter into a contract for a sale of goods or services, the portal 106 generates an electronic confirmation which is sent to both the seller 102 and the buyer 104 over lines 108 and 110.

The seller 102 is typically responsible for arranging shipment of the goods to the buyer 104. Logistics surrounding shipping the goods however tend to be very complicated and consume a substantial amount of the seller's 102 resources. The seller 104 either has in place or establishes a shipping contract with a variety of shipping service providers. For the purposes of this exemplary discussion, the seller 102 sends a request for shipping quote over lines 112, 114, and 116 to respectively a shipping broker 118, a first shipper 120, and a second shipper 122. Upon receipt of the seller's 102 request for quote, the shipping broker 118 sends a request for shipping quote over lines 124, 126, and 128 to respectively the first shipper 120, the second shipper 122, and a third shipper 130.

The shippers 120, 122, and 130 are typically either “common freight carriers” or “freight forwarders.” Common freight carriers include UPS, Federal Express, DSL, as well as others known within industry. Common carriers, however, tend to be very expensive, thus specialize in low volume, low weight aperiodic shipments. Thus, sellers needing to ship goods in high volume and/or of high weight often find common freight carriers too expensive.

Freight forwarders are shippers, such as interstate trucking lines, which tend to specialize in high-volume, high-weight shipments. Often freight forwarders, especially independent trucking lines, find that their shipping platforms (e.g. trucks, containers, box cars, etc.) are scheduled for delivery at less than full capacity. For instance, a flat-bed truck scheduled for a New York to Los Angeles route may be only half-full. Since freight forwarders operate most profitably with a full load of goods, they attempt to fill their unused capacity with paying cargo. Toward this end, the freight forwarders allocate significant resources for repeatedly contacting a variety of independent sources in search of goods to fill their unused capacity.

Shipping brokers (a.k.a. freight brokers) provide sellers with another option for arranging shipping. Shipping brokers include Roadway, Skyway, Consolidated Freight, GNA, as well as others known within industry. Shipping brokers reduce a seller's shipping cost by offering sellers a reduced overall shipping price in exchange for a periodic guaranteed minimum volume and/or weight of goods for shipment. Shipping brokers select either freight forwarders or common freight carriers for actual physical shipment of goods. Many sellers, especially those participating in internet auctions, however have varying volume and weight requirements and can not meet a shipping broker's volume and/or weight requirements over a guaranteed length of time.

In the example shown in FIG. 1, the first shipper 120 has been selected either directly by the seller 102 over line 116, or indirectly via the shipping broker 118 over lines 112 and 124. The first shipper 120 then receives the goods from the seller 102, as logically denoted by line 116, and ships them to the buyer 104, as logically denoted by line 132.

When sellers assume responsibility for initiating contact with shipping brokers and/or shippers, however, significant economic inefficiencies are introduced into the internet exchange supply chain. For example, many shippers who have unused capacity or offer a lower shipping rate may be overlooked by the seller 102 or the shipping broker 118 who do not have time to call these shippers, or may not even know of the shippers existence. Thus, sellers may have to pay higher shipping costs than otherwise were possible. The economic inefficiency of such seller handled shipping arrangements is even further compounded as hundreds of sellers and buyers participate in auctions on internet exchange portals on a daily basis.

Another problem with seller managed shipping regards fee collection by the internet exchange. In order to keep providing auction services, the internet exchange portal 106 collects a fee once a sales contract between the buyer and seller for the sale of goods and/or services is consummated. Consummation can occur at any time defined by the sales contract. Thus consummation may occur when the buyer enters in a contract with the seller, when the buyer actually makes payment to the seller, when the seller ships the good to the buyer, when the buyer receives and accepts the goods, or after any other event specified by the contract.

Since consummation may occur at a different for each transaction entered into by the buyer 104 and seller 102, the portal 106 is faced with a great deal of uncertainty as to when to begin contacting either the buyer or seller and collect the fee. Even if the portal required that all buyers and sellers agree to consummation upon a predetermined event, only the buyer and seller are typically aware that such event has occurred as they keep in communication over line 134.

To address this notice problem, exchange portals currently assign significant resources for repeatedly contacting sellers and buyers to ask whether the consummating event has occurred. Even after the consummating event has occurred, the portal 106 must still independently generate an invoice for collecting the fee. This is a very time consuming and laborious process.

In response to the concerns discussed above, what is needed is a method for aligning financial and logistical flows within an internet exchange portal that overcomes the problems of the prior art.

### SUMMARY OF THE INVENTION

The present invention is a method for aligning financial and logistical flows within an internet exchange portal. The method of the present invention includes the steps of facilitating an auction on the portal between a buyer and a seller, receiving an auction bid from the buyer, soliciting financing from a financing company in response to the auction bid, and soliciting shipping services from shippers in response to the auction bid.

The method of the present invention may further include the steps of facilitating an auction on the portal between a buyer and a seller; collecting a set of shipping data for a contract entered into between the buyer and seller resulting from the auction; soliciting bids for shipping services required by the contract; receiving a set of shipping bids; and selecting a bid from the set of bids according to a predetermined set of bid evaluation criteria.

In other aspects of the invention, the method may include the steps of: collecting a contract consummation event and billing an auction services fee upon occurrence of the event; specifying a bidding-period and processing only those bids received within the bidding-period; grouping together similar shipment needs for shippers and shipping brokers to submit a single bid upon; and soliciting unused capacity from shippers and shipping brokers for buyers and sellers to bid upon.

The method of the present invention is particularly advantageous over the prior art because fewer people are needed to administer financial and logistical alignment after a buyer has accepted and financed terms of a sale through the portal. Also, since the portal handles all financial and logistical flows upfront, there is ample time for the seller to gather and place purchased goods on a loading dock for shipment, and for freight forwarders to bid for providing shipping services.

The present invention also creates a competitive market for shipping services over the internet exchange and also greatly reduces the exchange's administrative overhead required to collect auction fees. Also, since the present invention enables shippers to bid for shipping business directly from the portal, the both the portal and shippers can avoid paying intermediate fees to shipping brokers.

Using the present invention, shippers have a competitive solution for filling unused capacity. Sellers using the present invention are able to rapidly transact and “cash out” inventory through the exchange portal without added administrative and logistical alignment costs associated with arranging necessary shipping.

Finally, since buyers need only deal with an internet exchange portal, which automatically aligns both financial and logistical transaction flows, the present invention greatly simplifies sales of goods over internet exchange portals. And from the buyer's perspective, the entire operation is transparent, and the buyer need only accept contract terms over the portal.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram of a typical financial and logistical flow within internet exchange system;

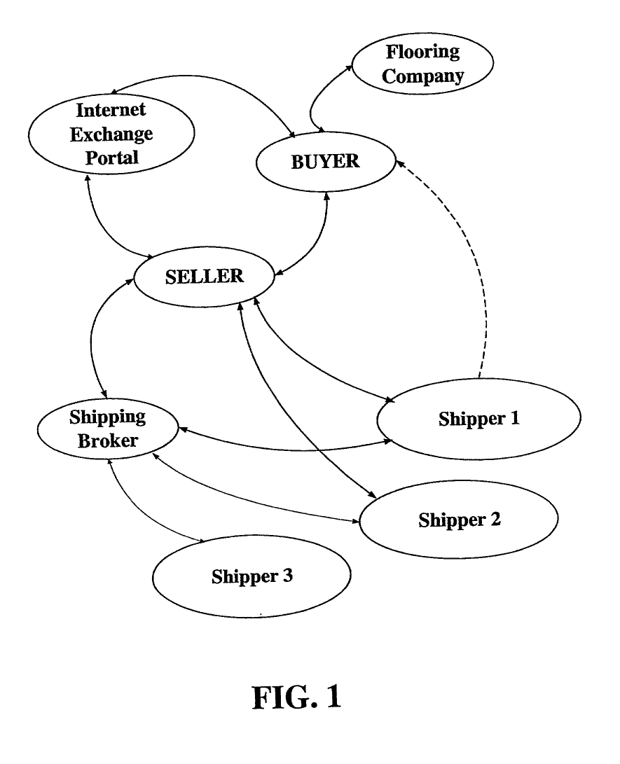

FIG. 2 is a dataflow diagram of a system for automatically aligning financial and logistical flows within an internet exchange portal; and

FIG. 3 is a flowchart of a method for automatically aligning financial and logistical flows within an internet exchange portal.

### DETAILED DESCRIPTION OF THE PREFERRED EMBODIMENT

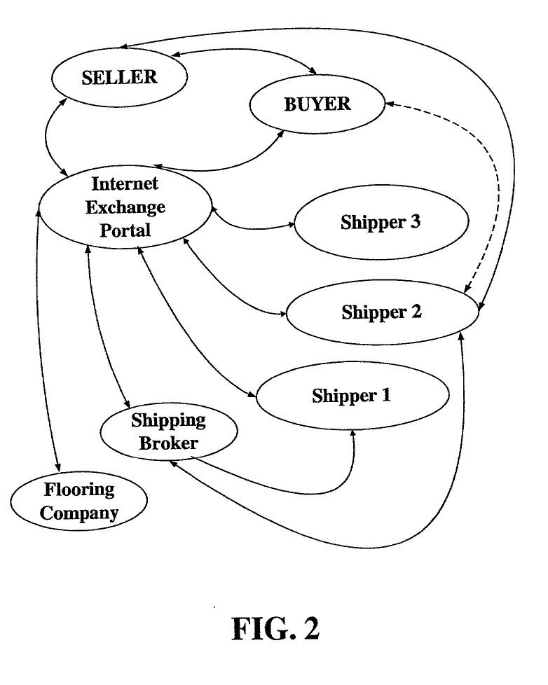

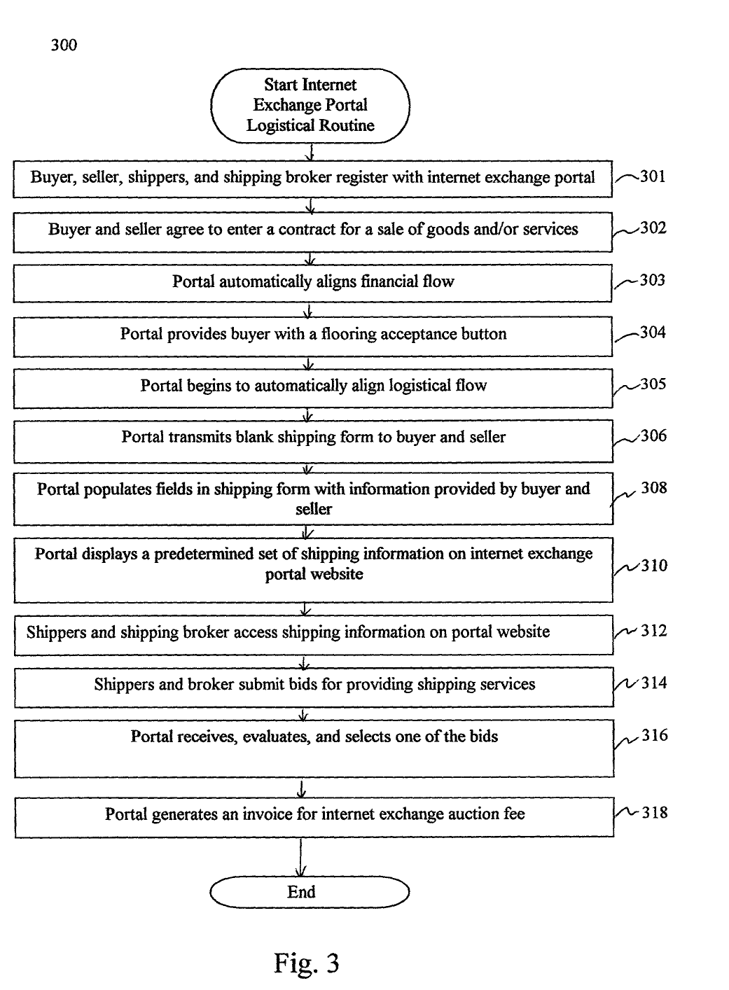

FIG. 2 is a dataflow diagram of an internet exchange system 200 for aligning financial and logistical flows within an internet exchange portal 202 configured to operate as an online Business-to-Business (B2B) auction, and FIG. 3 is a flowchart of a method 300 for doing so. A plurality of suppliers, dealers, resellers, and distributors are registered to transact business over the portal 202. The portal 202 may be configured either as a complex individual company or industry-wide supply chain in which there is rapid inventory turnover and associated financial and logistical flows needing alignment. The system 200 and method 300 are herein discussed together.

The method begins in step 301 where a seller 204, a buyer 206, a first shipper 208, a second shipper 210, a third shipper 212, and a shipping broker 214 register with the portal 202 over lines 216 through 226 in preparation for offering and bidding upon goods and services within auctions hosted and/or facilitated by the portal 202. While the present invention is discussed with respect to a single seller, buyer, three shippers, and a shipping broker, those skilled in the art recognize that the present invention can scale to any number of sellers, buyers, shippers, and brokers.

In step 302, the buyer 206 and seller 204 tentatively agree to enter a contract for a sale of goods and/or services. In response, the portal 202 automatically and immediately begins to align both financial and logistical flows necessary to complete terms of the contract. In step 303, the portal 202 aligns the financial flow between the buyer 206 and the seller 204 by soliciting flooring from a flooring company 227 over line 229. Those skilled in the art recognize that the portal 202 could also solicit flooring or other financing from any number of other credit providers.

Automatic flooring can be effected by the portal 202 by having the buyer 206 complete a generic flooring application which is then automatically forwarded to one or more flooring providers who then respond to the portal 202 with respective amounts of flooring credit available to the buyer 206. If the flooring company 227 approves sufficient credit necessary to the contract, the portal 202 provides the buyer 206 with an acceptance button which the buyer 206 clicks on to approve flooring credit, in step 304.

Certain ancillary communications related to the bid are transmitted between the buyer 206 and the seller 204 over line 231.

Once the buyer 206 clicks on the acceptance button, the portal 202 then begins to automatically align the logistical flow, in step 305. If the seller 204 agrees to ship goods to the buyer 206 as part of the contract, the portal 202 transmits a shipping form to the buyer 206 and the seller 204 over lines 218 and 216 respectively, in step 306.

The shipping form includes a set of shipping fields for storing shipping data/information. The shipping data includes buyer and seller identification, an origination address, a destination address, shipping weight, shipping quantity, shipping volume, delivery time, a consummation event, a bidding-period, as well as other information customarily associated with shipping goods. The consummation event is a predetermined contract event which defines with certainty when the portal 202 can collect an auction services fee for providing auction services to the buyer 206 and seller 204. Since the portal 202 stores the consummation event locally and arranges shipping, the portal 202 need not contact the buyer 206 and seller 204 to determine when to invoice the fee. The bidding-period is a predetermined window of time during which either the seller 204 or buyer 206 must have the goods shipped. The bidding-period may even be as short as 24 to 48 hours.

The portal 202, in step 308, populates the fields in the shipping form with information provided by the buyer and seller. In step 310, the portal 202 displays a predetermined set of shipping information on an internet exchange portal website. In an alternate embodiment, the portal 202 sorts through a set of shipments scheduled between any number of sellers and buyers. The portal 202 then groups shipments within the set by a common seller, a common buyer, a common origination location, a common destination location, a common delivery time, as well as other common shipping information within the set of shipments. Grouping by the portal 202 can further increase logistical and economic efficiencies of the internet exchange auction.

In step 312, the shippers 208, 210, 212 and shipping broker 214 access the shipping information on the portal website over lines 220 through 226 respectively. The shippers and broker then submit bids for providing shipping services to the buyer 206 and seller 204, in step 314. Note, some shippers or brokers may chose not to submit a bid.

In step 316, the portal 202 receives and evaluates each of the bids. Depending upon individual registration agreements between the portal 202, the buyer 206, and the seller 204, the portal 202 may: select one of the bids automatically according to a predetermined set of bid evaluation criteria; forward the bids on to the buyer 206 and the seller 204 so that the buyer 206 and seller 204 can directly select one of the bids; or follow some other procedure known to those skilled in the art.

The set of bid evaluation criteria can: select a bid with a lowest shipping price; factor in a shipper's on-time delivery performance, volume discounts, and/or prior relationship with either the portal 202, the buyer 206, or the seller 204. Those skilled in the art recognize other bid evaluation criteria which may be given weight by the portal 202. If none of the bids are acceptable, the portal 202 assigns shipping to a predetermined shipper or shipping broker as defined within the registration agreements. In FIG. 2, the second shipper 210 has been selected to provide shipping services. Lines 228 and 230 represent communications between the second shipper 210 and the seller 204 and the buyer 206 related toward actually shipping the goods.

In step 318, the portal 202 generates an invoice for the auction fee and submits the invoice to either the seller or the buyer upon occurrence of the consummating event. Thus, since the shipping information includes the consummation event, the portal can determine with certainty a date after which the auction fee may be collected. This significantly reduces administrative resources required by the portal 202 for fee collection, and thus gives the portal 202 an opportunity to lower its commissions.

In an alternate embodiment, the portal 202 renders an individualized hyperlinked logo of the second shipper 210 on the portal webpage which the buyer 206 and seller 204 may select in order to obtain shipment status information.

In another alternate embodiment of the present invention, the portal 202 auctions a shipper's and shipping broker's unused capacity. Buyers and sellers may then directly bid for the unused capacity over the portal 202. The portal 202 also charges a fee for providing this service.

While one or more embodiments of the present invention have been described, those skilled in the art will recognize that various modifications may be made. Variations upon and modifications to these embodiments are provided by the present invention, which is limited only by the following claims.

What is claimed is:

1. A method for aligning transactional flows within an internet exchange portal, comprising the steps of:
facilitating an auction on the portal between a buyer and a seller;
receiving an auction bid from the buyer;
soliciting financing from a financing company in response to the auction bid; and
soliciting shipping services from shippers in response to the auction bid.

2. The method of claim 1 wherein the soliciting financing step includes the step of:
soliciting flooring from a flooring company in response to the auction bid.

3. The method of claim 2 further including the steps of:
soliciting financing from additional financing companies in response to the auction bid;
providing the buyer with a set of flooring credit lines from the financing companies; and
selecting a flooring credit line from the set in response to a signal from the buyer.

4. A method for aligning transactional flows within an internet exchange portal, comprising the steps of:
facilitating an auction on the portal between a buyer and a seller;
collecting a set of shipping data for a contract entered into between the buyer and seller resulting from the auction;
soliciting bids for shipping services required by the contract;
receiving a set of shipping bids; and
selecting a bid from the set of bids according to a predetermined set of bid evaluation criteria.

5. The method of claim 4 wherein the facilitating step of includes the step of:
facilitating a business-to-business auction on the portal.

6. The method of claim 4:
wherein the collecting step includes the step of collecting a contract consummation event; and
further comprising the step of billing an auction services fee upon occurrence of the event.

7. The method of claim 4 wherein:
the collecting step includes the step of collecting a bidding-period; and
the receiving step further comprising the step of receiving a set of shipping bids within the bidding-period.

8. The method of claim 4:
wherein the shipping data is organized into a set of shipping fields;
wherein the collecting step includes the step of collecting additional sets of shipping data corresponding to additional contracts;
further comprising the step of grouping together those contracts having equivalent shipping data within at least one of the shipping fields; and
wherein the soliciting step includes the step of soliciting bids for providing shipping services for the group of contracts.

9. The method of claim 4 wherein the soliciting step of includes the step of:
soliciting bids for shipping services from a plurality of shippers and shipping brokers.

10. The method of claim 4 wherein the soliciting step of includes the step of:
displaying a predetermined set of shipping data on an internet exchange portal website accessible to shippers and shipping brokers.

11. The method of claim 4 wherein the facilitating step of includes the step of:
collecting the predetermined set of bid evaluation criteria from the seller.

12. The method of claim 4 wherein the selecting step of includes the steps of:
forwarding the bids onto the seller; and
receiving a bid selection from the seller.

13. The method of claim 4 wherein the selecting step of includes the steps of:
selecting a bid with a lowest shipping price.

14. The method of claim 4 wherein the selecting step of includes the steps of:
selecting a default shipper if none of the bids conform to the predetermined set of bid evaluation criteria.

15. A method for transactional flows within an internet exchange portal, comprising the steps of:
soliciting unused capacity for providing shipping services to buyers and sellers who participate in auctions facilitated by the portal from shippers; and
receiving a set of bids from the buyers and sellers for the unused capacity.

16. A computer-usable medium embodying computer program code for causing a computer to align transactional flows within an internet exchange portal, comprising the steps of:
facilitating an auction on the portal between a buyer and a seller;
collecting a set of shipping data for a contract entered into between the buyer and seller resulting from the auction;
soliciting bids for shipping services required by the contract;
receiving a set of shipping bids; and
selecting a bid from the set of bids according to a predetermined set of bid evaluation criteria.

17. The computer-usable medium of claim 16 wherein the facilitating step of includes the step of:
facilitating a business-to-business auction on the portal.

18. The computer-usable medium of claim 16:
wherein the collecting step includes the step of collecting a contract consummation event; and
further comprising the step of billing an auction services fee upon occurrence of the event.

19. The computer-usable medium of claim 16 wherein:
the collecting step includes the step of collecting a bidding-period; and
the receiving step further comprising the step of receiving a set of shipping bids within the bidding-period.

20. The computer-usable medium of claim 16:
wherein the shipping data is organized into a set of shipping fields;
wherein the collecting step includes the step of collecting additional sets of shipping data corresponding to additional contracts;
further comprising the step of grouping together those contracts having equivalent shipping data within at least one of the shipping fields; and
wherein the soliciting step includes the step of soliciting bids for providing shipping services for the group of contracts.

21. The computer-usable medium of claim 16 wherein the soliciting step of includes the step of:
soliciting bids for shipping services from a plurality of shippers and shipping brokers.

22. The computer-usable medium of claim 16 wherein the soliciting step of includes the step of:
displaying a predetermined set of shipping data on an internet exchange portal website accessible to shippers and shipping brokers.

23. The computer-usable medium of claim 16 wherein the facilitating step of includes the step of:
collecting the predetermined set of bid evaluation criteria from the seller.

24. The computer-usable medium of claim 16 wherein the selecting step of includes the steps of:
forwarding the bids onto the seller; and
receiving a bid selection from the seller.

25. The computer-usable medium of claim 16 wherein the selecting step of includes the steps of:
selecting a bid with a lowest shipping price.

26. The computer-usable medium of claim 16 wherein the selecting step of includes the steps of:
selecting a default shipper if none of the bids conform to the predetermined set of bid evaluation criteria.

27. A computer-usable medium embodying computer program code for causing a computer to align transactional flows within an internet exchange portal, comprising the steps of:
soliciting unused capacity for providing shipping services to buyers and sellers who participate in auctions facilitated by the portal from shippers; and
receiving a set of bids from the buyers and sellers for the unused capacity.
